(19) United States
(12) Patent Application Publication
(10) Pub. No.: US 2004/0059863 A1
(43) Pub. Date: Mar. 25, 2004

(54) Method of optimizing storage for streaming video

(76) Inventors: Rick Andrew, Dallas, TX (US); Kevin Yahl, Orland Park, IL (US)

Correspondence Address: CARSTENS YEE & CAHOON, LLP, P O BOX 802334, DALLAS, TX, 75380

(21) Appl. No.: 10/251,452

(22) Filed: Sep. 20, 2002

(51) Int. Cl. G06F 12/00

(52) U.S. Cl. 711/1

(57) ABSTRACT

A method for removing cookies, temporary Internet files, and defragmenting a hard drive to optimize streaming video performance. A program residing on a computer automatically (and configurably) removes cookies and temporary Internet files from a hard drive, and defragments the hard drive on shutdown of the computer system.

### BACKGROUND OF THE INVENTION

1. Technical Field

The present application is directed generally to computer technology, and more particularly toward viewing streaming video across a network.

2. Description of Related Art

Cookies and Temporary Internet Files

HTTP (Hyper Text Transfer Protocol) is a stateless (i.e., not-persistent) protocol used for communicating on the World Wide Web. Web servers are generally incapable of differentiating between website visits by clients. This is a limitation to the client/server interaction on the Internet. For example, web sties may need to save session information about clients, or assign clients passwords and IDs to associate transactions with clients.

Cookies are a tool allowing the maintenance of state information on the Internet. A cookie is a small amount of data that a web server saves on a client system and can later retrieve from the client system. Cookies are typically used by server side code such as CGI (Common Gateway Interface) scripts. Cookies are managed on the client side by the client's browser program.

Though individual cookies are small amounts of data, surfing the web can cause accumulation of cookies on a client machine. Not all cookies are desirable to have on a client machine, and cookies are frequently placed on client machines through routine Internet browsing. For example, the ubiquitous pop-up banners which automatically load with some websites can transfer unnecessary or unwanted cookies to a client machine.

Temporary Internet files, a type of cache file acquired through surfing the Internet, also accumulate on a user's hard drive. Though temporary Internet files can make some web pages load faster, their accumulation on a hard drive can degrade performance. Removing temporary Internet files does not prevent web surfing or accessing web pages, though it can cause brief delays as sites. But with increasing bandwidth of Internet access, these associated delays are negligible.

The constant accumulation of cookies and temporary Internet files can add to and increase the rate of fragmentation of a user's hard drive. Fragmentation of a hard drive causes the rate at which data can be accessed from the hard drive to slow.

Swapping

Swapping is to replace pages or segments of data in memory. Swapping is a useful technique that enables a computer to execute programs and manipulate data files larger than main memory. The operating system copies as much data as possible into main memory, and leaves the rest on the disk. When the operating system needs data from the disk, it exchanges a portion of data (called a page or segment) in main memory with a portion of data on the disk.

Swapping is commonly used to view data intensive files such as streaming video or DVD (digital video disc) files. When a computer displays DVD, for example, the hard drive is accessed to find the necessary decode string to decode the compressed mpeg-2 video data. When more memory is needed to decode the data, the swap file grows as needed. The more fragmented a hard drive is, the longer the swap file takes to access the needed information from the hard drive.

Therefore there is a need in the art to reduce fragmentation of hard drives for data intensive applications such as streaming video.

### SUMMARY OF THE INVENTION

The present invention presents an improved system and method for displaying streaming video on a computer. In a preferred embodiment, the innovation is implemented in software. This embodiment comprises a method of maintaining the system's storage to maximize streaming video performance on a computer. This embodiment includes the steps of sweeping the hard drive free of unwanted cookies; sweeping the hard drive free of unwanted temporary Internet files, and defragmenting the hard drive. These steps are preferably invoked at shutdown and/or restart, depending on user-configurable settings and automatic promptings by the system implementing the innovative concept.

More generally, a preferred embodiment comprises the removal of unwanted files deposited on a hard drive by a server, typically through the course of Internet browsing. After removal of the unwanted files, the hard drive is defragmented, which decreases the seek time for decode strings on the hard drive. The innovative process preferably is automatically invoked on shutdown or restart of the computer system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a computer in which a preferred embodiment can be implemented.

FIG. 2 shows a block diagram of a typical data processing system.

FIG. 3 shows an example of a networked communications system in which a preferred embodiment can be implemented.

FIG. 4 shows process steps for implementing a preferred embodiment.

FIG. 5 shows alternative process steps for implementing a preferred embodiment.

### DETAILED DESCRIPTION OF THE PREFERRED EMBODIMENT

The present innovative ideas are described with reference to the Figures. The following embodiments are intended to teach the current innovations by way of example and not of limitation.

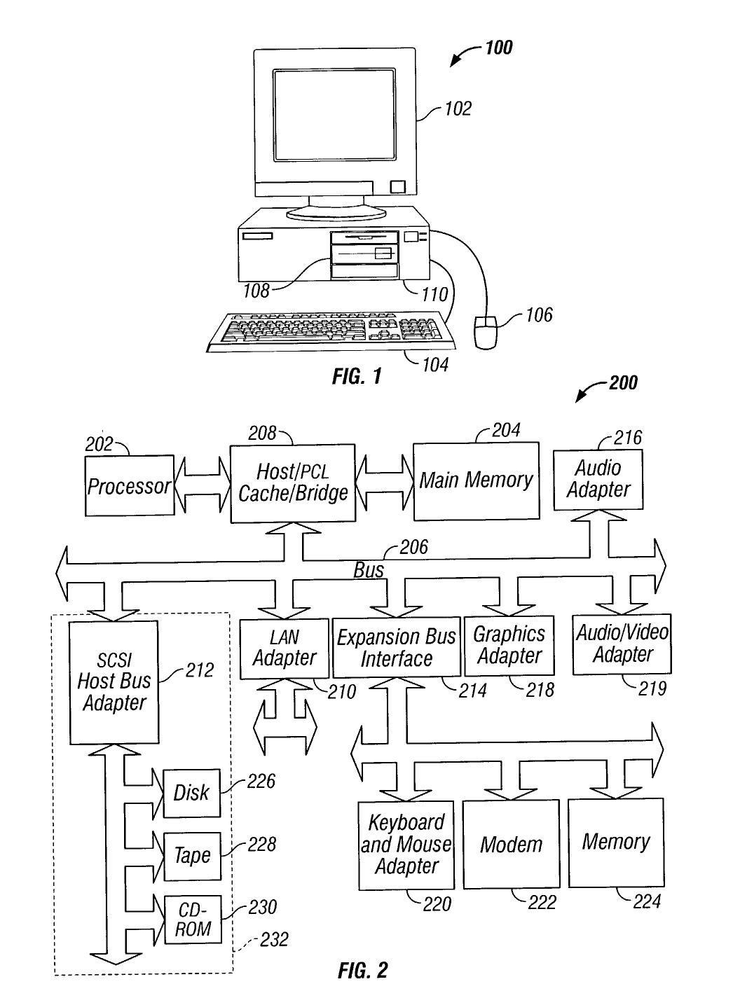

With reference now to the figures and in particular with reference to FIG. 1, a pictorial representation of a data processing system in which the present invention may be implemented is depicted in accordance with a preferred embodiment. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors. An operating system runs on processor 202 and is used to coordinate and provide control of various components within data processing system 200 in FIG. 2.

The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM or DVD player 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

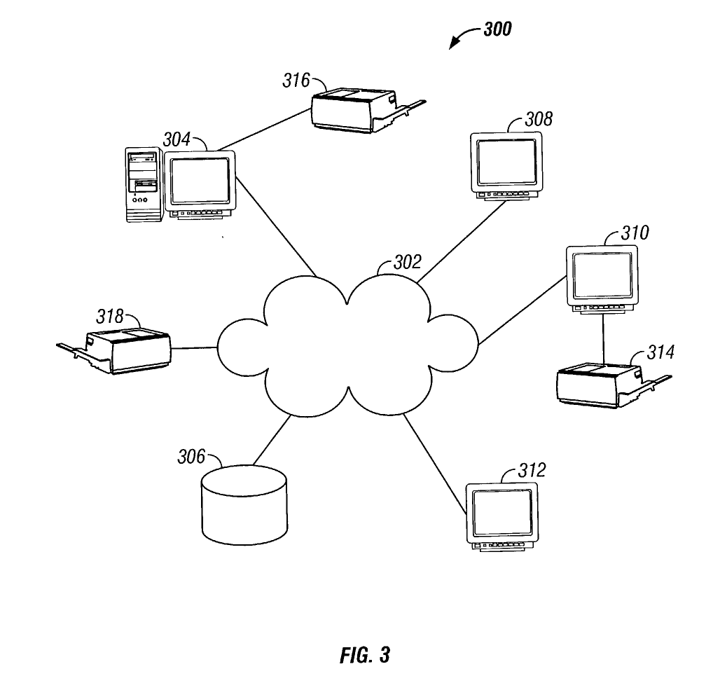

FIG. 3 depicts a pictorial representation of a network of data processing systems in which the present invention may be implemented. Network data processing system 300 is a network of computers in which the present invention may be implemented. Network data processing system 300 contains a network 302, which is the medium used to provide communications links between various devices and computers connected together within network data processing system 300. Network 302 may include connections, such as wire, wireless communication links, or fiber optic cables.

In the depicted example, a server 304 is connected to network 302 along with storage unit 306. In addition, clients 308, 310, and 312 also are connected to network 302. These clients 308, 310, and 312 may be, for example, personal computers or network computers. In the depicted example, server 304 provides data, such as boot files, operating system images, and applications to clients 308-312. Clients 308, 310, and 312 are clients to server 304. Network data processing system 300 includes printers 314, 316, and 318, and may also include additional servers, clients, and other devices not shown.

In the depicted example, network data processing system 300 is the Internet with network 302 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 3 is intended as an example, and not as an architectural limitation for the present invention.

The present innovations are preferably implemented as software on a computer system and/or network as described. Preferably, the software implementation resides on an individual user's computer, though other arrangements are of course possible (such as the software residing across a network connection).

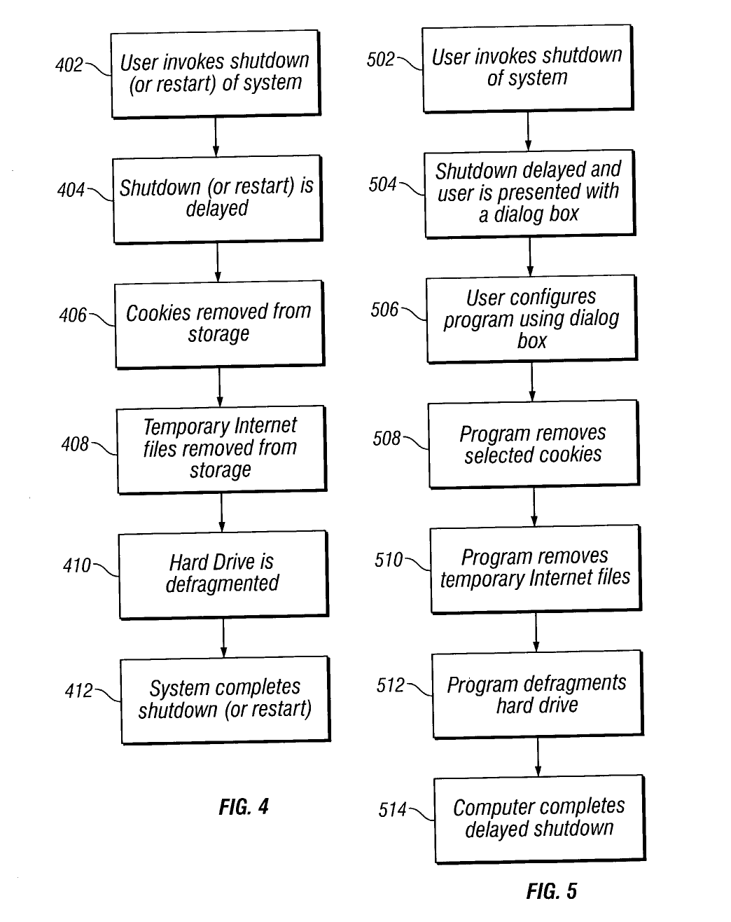

FIG. 4 shows a flowchart of process steps for a preferred embodiment. When a user is ready to end use of the computer system, the user invokes shutdown (or in some embodiments, restart) of the system (step 402). The shutdown (or restart) is delayed (step 404). At that time, the process is invoked by which cookies are removed from the hard drive (step 406). This step can automatically remove all cookies on the hard drive, or it can remove only selected cookies, as described below.

Next, temporary Internet files are removed from the computer system hard drive (step 408). Again, this step can have a default setting where all temporary Internet files are removed, or can be user configurable so that only selected temporary Internet files are removed.

After temporary Internet files are removed from the hard drive, the hard drive is defragmented (step 410). Removing temporary Internet files and cookies placed on the hard drive since the last shutdown (assuming the innovative software was already in place at that time) allows these files to be removed before defragmentation occurs, which increases the speed with which defragmentation is executed. After defragmentation is complete, the computer automatically completes the delayed shutdown (or restart) (step 412).

Invocation of the steps of FIG. 4 preferably occurs at shutdown of the computer system. If a user merely restarts the computer system, all, some, or none of the steps of FIG. 4 can be implemented, depending on user selected preferences. For example, if a user intends to restart the computer after having installed a software program, then defragmenting the hard drive at restart would effectively undo the installation of the software. In such a case, the user would preferably be presented with a dialog box (or other input means) so as to choose the desired functions. In this example, the user would restart the computer without the defragmentation process being invoked. The computer could still remove all selected cookies and temporary files.

As mentioned, all the steps of the innovative process can be configured by the user. For example, the removal of all cookies would also remove cookies which the user may not wish to eliminate—such as those from a trusted and frequently visited website. While removing these cookies causes no harm to the system, the user may nevertheless desire to keep them. In this case, a browser window (for example) would open the temporary Internet files folder (or another location of cookies and temporary Internet files) allowing the user to select exactly which cookies should be deleted and which kept. Once a user has gone through this process, the settings are preferably saved so that each time the innovative process is invoked, the user's selected files are retained.

Of course, these configuration options also apply to the removal of temporary Internet files. For example, some graphics may require large amounts of data, and therefore may download across a network connection slowly. Normally, such a file may be cached so that the graphic can be displayed directly from cache memory rather than from the server on which it normally resides. A user may therefore decide to retain some temporary Internet files.

The defragmentation process is also configurable, for example, a user may select when defragmentation should occur (e.g., on shutdowns only, or on restarts as well) or a user may select an abbreviated defragmentation process if the system is so enabled.

Some or all of the innovative process steps may be invoked at shutdown of the system. Likewise, some or all may be invoked on restart of the system—all according to user configuration. If the user declines to alter the default configuration (or the last configuration created, which preferably becomes default), then the default configuration determines what process steps are taken.

The selection of what cookies (for example) are retained can be further improved by allowing the innovative process to group cookies according to their source. For example, the user may desire to retain all cookies from a trusted and frequently visited website. The configuration interface would preferably automatically group all cookies from that site, so that the user can easily select to retain all cookies from that site. Likewise, temporary Internet files can preferably be grouped for easy selection.

Groupings based on other than source can also be used to classify cookies and temporary Internet files. For example, size could be the grouping parameter. The grouping parameter (i.e., the quality by which cookies, etc. are grouped) is preferably user configurable.

The innovative concepts are not necessarily limited to cookies and temporary Internet files only, and are more generally described as files deposited on a user's computer (usually storage or hard drive 226) by a server during the course of browsing the Internet or viewing other files across a network. When a computer communicates across a network, files are often deposited on the user's computer, as described previously. Many of such files are unnecessary or unwanted under some circumstances. Cookies and temporary Internet files are exemplary of those files removed by the present innovations, but the present innovations are not limited to removing those particular files. For example, a user may desire to retain all cookies, but delete temporary Internet files or cache files. Or a user might prefer to retain cookies and temporary Internet files and remove only those files which have been recentiy downloaded into a particular folder (though this is a less preferred embodiment).

FIG. 5 shows a variation on the innovative process, including steps for user configuration. First, the user invokes shutdown (or restart) of the system (step 502). The shutdown (or restart) of the system is delayed and the user is presented with a dialog box or other interactive input (step 504). The dialog box offers the user the chance to alter the default settings of the innovative process. For example, the user can configure whether the defragmentation or removal of files should be performed or not, and what files should be removed. The user can preferably be presented with preselected groups of files to facilitate easier selection, as described above.

Next, the user uses the dialog box to configure the innovative process (step 506) as described. The process is then launched and first removes selected cookies (step 508) and temporary Internet files (step 510), and then defragments the hard drive (step 512). Of course any or all of these steps may be bypassed, according to the user configuration from step 506.

After the desired processes are run, the computer completes the delayed shutdown (or restart) (step 514).

The present innovations are advantageous for the reasons discussed. It should also be noted that if a hard drive is not defragmented for long periods of time, the degree of defragmentation that can be achieved can be reduced, meaning that the hard drive can effectively never be fully defragmented. Defragmenting frequently also decreases the required time to defragment the hard drive.

Note that some of the terms used in this specification are intended to be generally construed, and not narrowly. For example, though the innovations are described with reference to a hard drive, any type of storage which is subject to fragmentation is consistent with the implementing the innovative concepts herein described.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of maintaining a computer system, comprising the steps of:
removing selected cookies from a storage of the computer system;
removing selected temporary Internet files from the storage;
defragmenting the storage;
wherein the steps of removing selected cookies, removing selected temporary Internet files and defragmenting are automatically invoked on shutdown of the computer system.

2. The method of claim 1, wherein the steps of removing selected cookies and removing selected temporary Internet files are also automatically invoked on restart of the computer system.

3. The method of claim 1, wherein when the steps of removing selected cookies, removing selected temporary Internet files and defragmenting are invoked, a user of the computer system is given an option to prevent invocation of at least one of these steps.

4. The method of claim 1, wherein the step of defragmenting comprises an abbreviated defragmentation process.

5. The method of claim 1, wherein the user is presented with an option to determine what cookies are selected cookies upon invocation of the step of removing selected cookies.

6. The method of claim 5, wherein cookies from a common source are grouped together such that a user can select to eliminate or retain all cookies from that source as a single group.

7. A computer program, comprising:
means for removing selected cookies from a storage of the computer system;
means for removing selected temporary Internet files from the storage;
means for defragmenting the storage;
wherein the means for removing selected cookies, means for removing selected temporary Internet files, and means for defragmenting are automatically invoked on shutdown of the computer system.

8. The program of claim 7, wherein removing selected cookies and removing selected temporary Internet files are also invoked on restart of the computer system.

9. The program of claim 7, wherein when the removal of cookies, removal of selected temporary Internet files, and defragmentation of the storage is invoked, a user of the computer system is given an option to prevent invocation of at least one of these steps.

10. The program of claim 7, wherein cookies from a common source are grouped together such that a user can select to eliminate or retain all cookies from that source as a single group.

11. A method of maintaining a computer storage, comprising the step of:
at a designated time, automatically invoking a software process, wherein the process includes the steps of:
presenting a user with an option to designate cookies to remove from a computer storage;
presenting a user with an option to designate temporary Internet files from the computer storage;
removing designated cookies from the storage;
removing temporary Internet files form the storage;
defragmenting the computer.

12. The method of claim 11, wherein the designated time is shutdown of the computer system.

13. The method of claim 11, wherein cookies from a common source are grouped together such that a user can select to eliminate or retain all cookies from that source as a single group.

14. The method of claim 11, wherein the steps of removing designated cookies and removing temporary Internet files are invoked at restart of the computer.

15. A method of maintaining a hard drive on a computer system for optimal display of streaming video, comprising the steps of:
removing recently acquired files from the hard drive, the files having been deposited on the hard drive by a server across a network connection;
defragmenting the hard drive;
wherein the steps of removing and defragmenting are automatically performed upon shutdown or restart of the computer system.

16. The method of claim 15, wherein the recently acquired files are cookies and temporary Internet files.

17. A method of maintaining a hard drive on a computer system for optimal display of streaming video, comprising the steps of:
removing recently acquired files from the hard drive, the files deposited on the hard drive by a server across a network connection;
decreasing seek time for a decode string for streaming video by defragmenting the hard drive.

18. The method of claim 17, wherein the steps of removing and decreasing are automatically performed prior to shutdown of the computer system.

19. The method of claim 17, wherein the recently acquired files are cookies and temporary Internet files.

20. The method of claim 17, wherein the steps of removing and decreasing are performed on shutdown of the computer system.
